(19) United States
(12) Patent Application Publication
(10) Pub. No.: US 2007/0143275 A1
(43) Pub. Date: Jun. 21, 2007

(54) Work-context search strings for work-embedded e-learning

(75) Inventors: Elizabeth V. Bagley, Cedar Park, TX (US); Frank McGrath, Lexington, MA (US); Pamela A. Nesbitt, Tampa, FL (US); William C. Tobin, Chelmsford, MA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/314,984

(22) Filed: Dec. 21, 2005

(51) Int. Cl. G06F 17/30

(52) U.S. Cl. 707/4

(57) ABSTRACT

Embodiments of the present invention address deficiencies of the art in respect to e-learning and provide a novel and non-obvious method, system and computer program product for contextually invoking e-learning services for work-embedded e-learning. In one embodiment, a method for on-demand work-embedded learning can be provided. The method can include trapping a pre-configured event in an application executing in a host computing platform, and identifying a context for the pre-configured event. The method further can include retrieving e-learning content corresponding to the identified context from a learning management system. Finally, the method can include rendering the retrieved e-learning content in an e-learning content view which is separate from a view for the application in the host computing platform.

### BACKGROUND OF THE INVENTION

1. Field of the Invention

The present invention relates to e-learning and more particularly to dynamic invocation of e-learning services.

2. Description of the Related Art

E-learning relates to the computer facilitated presentation of knowledge to students utilizing computing technologies and particular computer communications networks. With regard to the latter, the vast coverage of the modern Internet provides a bottomless resource for distributing knowledge far beyond the limitations of the conventional classroom. So vast has the reach of e-learning technologies been perceived, that entire sub-technologies have been developed to support e-learning efforts. These technologies include content organization and retrieval technologies such as the ADL Shareable Content Object Reference Model (SCORM) and AICC. These technologies further include large scale learning management systems.

Learning management systems provide for the total management of an on-line learning experience—from content creation to course delivery. A properly organized learning management system is an educational program that allows students to partake in a “classroom” setting from any location via the Internet. In the prototypical learning management system, one or more course offerings can be distributed over a computer communications network for delivery to students enrolled in one or more corresponding courses. The course offerings can include content which ranges from mere text-based instructional materials to full-blown interactive, live classroom settings hosted entirely through the computer communications network. So advanced to date has the ability of learning management systems to deliver content become, that nearly any learning experience formerly delivered through in-person instruction now can be delivered entirely on-line and even globally over the Internet.

While learning management systems have proven successful in the traditional notion of remote education, learning management systems suffer from some of the same problems associated with conventional learning. In this regard, in both conventional learning and e-learning, a class must be registered into a pre-arranged course meeting at a particular time, albeit remotely. Consequently, e-learning generally is not suitable for on-demand learning applications. In particular, industrial training involves both structured, pre-scheduled learning and on-demand learning. In the case of the former, e-learning through learning management systems fares well, while in the case of the latter, e-learning falls short of expectations.

On-demand learning in the workplace is better known as on-line help where an employee interacts with a computing application or workflow task only to encounter a condition unfamiliar to the employee. In conventional computing, the employee can invoke on-line help in order to search an index for a local repository for an appropriate help entry providing basic, help instructions. More sophisticated help systems might provide a proper page of locally stored help text which is associated with the current view of an application. Even more sophisticated help systems might retrieve help text from a Web site using a pre-determined uniform resource locator (URL) for the help page.

Notwithstanding, on-line help is not comparable to e-learning. E-learning provides a robust learning experience for the end user. In fact, the intent of on-line help is to provide basic information relating to a function of an application, whereas e-learning provides on-line training to the employee-student. In the past, the learning requirements of slow growing industry permitted the sole existence of on-line help inasmuch as traditional classroom training could be attained periodically at the convenience of the corporate trainer. Yet, today's fast paced industrial requirements do not permit mere periodic live training sessions. Accordingly, the advantages of e-learning for on-demand industrial training, referred to in the art as “work embedded learning”, have become a learning strategy of paramount importance, where precisely measured guidance can be delivered to an employee at the exact moment of need without interrupting the flow of work.

### BRIEF SUMMARY OF THE INVENTION

Embodiments of the present invention address deficiencies of the art in respect to e-learning and provide a novel and non-obvious method, system and computer program product for contextually invoking e-learning services for work-embedded e-learning. In one embodiment, a method for on-demand work-embedded learning can be provided. The method can include trapping a pre-configured event in an application executing in a host computing platform, and identifying a context for the pre-configured event. The method further can include retrieving e-learning content corresponding to the identified context from a learning management system. Finally, the method can include rendering the retrieved e-learning content in an e-learning content view which is separate from a view for the application in the host computing platform.

In one aspect of the invention, identifying a context for the pre-configured event can include identifying for the pre-configured event, an identity for each of an application, task within the application and associated user interface control for the application. In another aspect of the invention, retrieving e-learning content corresponding to the content from a learning management system can include generating a search string for the context, transmitting the search string to a learning management system over a computer communications network, and receiving e-learning content corresponding to the search string from the learning management system.

Another embodiment can provide a data processing system configured for on-demand work-embedded learning. The data processing system can include a host computing platform communicatively coupled to a learning management system and one or more applications executing in the host computing platform. The data processing system further can include an e-learning view executing separately from the applications in the host computing platform. Finally, the data processing system can include e-learning invocation logic disposed in the host computing platform.

The logic can include program code enabled first to build a search string for a context responsive to detecting a pre-configured event originating from one of the applications, and second to provide e-learning content retrieved for the context from the learning management system to the e-learning content view. In one aspect of the embodiment, the context can be an identity for each of an application, task within the application and associated user interface control for the application. Likewise, in another aspect of the embodiment, the associated user interface control can be a user interface control having focus during the pre-configured event.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration a host user interface configured for contextually invoking e-learning services for work-embedded e-learning;

FIG. 2 is a schematic illustration of an e-learning data processing system configured for contextually invoking e-learning services for work-embedded e-learning; and,

FIG. 3 is a flow chart illustrating a process for contextually invoking e-learning services for work-embedded e-learning.

### DETAILED DESCRIPTION OF THE INVENTION

Embodiments of the present invention provide a method, system and computer program product for contextually invoking e-learning services for work-embedded e-learning. In accordance with an embodiment of the present invention, a contextual search string can be retrieved for an application responsive to the activation of an e-learning event. The contextual search string can indicate each of a task and selected control for the application. The retrieved contextual search string can be provided over a computer communications network to a learning management system. Subsequently, e-learning content associated with the application, task and selected control can be provided by the learning management system and be rendered separately from the application.

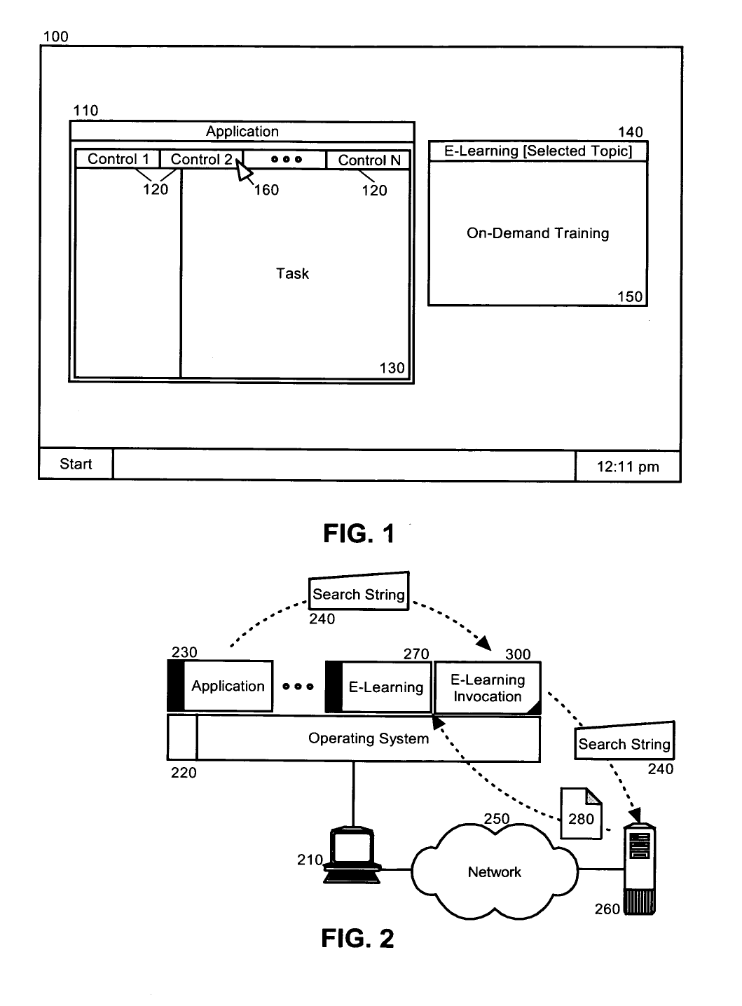

In more particular illustration, FIG. 1 is a pictorial illustration a host user interface configured for contextually invoking e-learning services for work-embedded e-learning. The host user interface can include a desktop environment 100 for an operating system. The desktop environment 100 can include multiple application windows including an application window for an application 110 and an application window for an e-learning content viewer 140. The application 110 can include one or more task views 130 for selected tasks in the application 110, and one or more user interface controls 120 for activating operations in each of the task views 130.

Notably, the desktop environment 100 can be configured to detect an e-learning event originating from the application 110. For instance, the e-learning event can be a pre-defined set of keystrokes activated in the application 110. The desktop environment 100 further can be configured to construct a search string from the identity of the application 110, the identity of the task within an active one of the task views 130 at the time of the e-learning event, and a selected one of the user interface controls 120 at the time of the e-learning event. Utilizing the constructed search string, e-learning content can be retrieved from a learning management system and rendered as on-demand training content 150 in the e-learning content viewer 140.

In further illustration, FIG. 2 is a schematic illustration of an e-learning data processing system configured for contextually invoking e-learning services for work-embedded e-learning. As shown in FIG. 2, the e-learning data processing system can include a host computing platform 210 including an operating system 220. The operating system 220 can support the execution of one or more applications 230 which can include a stand-alone, executable application or a content browser displaying a network distributable application—for example a Web or portal based application.

In accordance with the present invention, the operating system 220 further can support the execution of an e-learning application 270. The e-learning application 270 can range from a dedicated viewer of e-learning content to a mere content browser enabled to render e-learning content. In this regard, the host computing platform 210 can be communicatively coupled to a learning management system 260 over a computer communications network 250. The learning management system 260 can range from a mere content server enabled to serve markup language specified e-learning content to the host computing platform 210 for rendering in the e-learning view 270, to a dedicated learning management system.

Importantly, e-learning invocation logic 300 can be coupled to the operating system 220. The e-learning logic 300 can include program code enabled to trap a pre-selected event emanating from one or more of the applications 230. The program code can be further enabled as an event handler to process the pre-selected event by retrieving identities for each of an application, task within the application and associated user interface control associated with the pre-selected event. Preferably, the identities for the application, task and user interface control can relate to the selection of the user interface control for a task in the application at the time of the pre-selected event. In this regard, the identity of the application can be obtained by reference to a window title through a handle to the window provided by the operating system. Similarly, contextual information relating to the application, including an active task or in-focus user interface control can be obtained through an interface to the user interface of the application provided by the operating system, as it is well-known in the art.

Finally, the program code can be enabled both to generate a search string 240 with the identities and to forward the search string 240 to the learning management system 260. The learning management system 260, in turn, can process the search string 240 to locate corresponding e-learning content 280. Subsequently, the learning management system 260 can forward the located e-learning content 280 to the host computing platform 210 over the computer communications network 250 for rendering in the e-learning view 270. In this way, on-demand, work-embedded learning can be provided without requiring modification to the underlying applications 230.

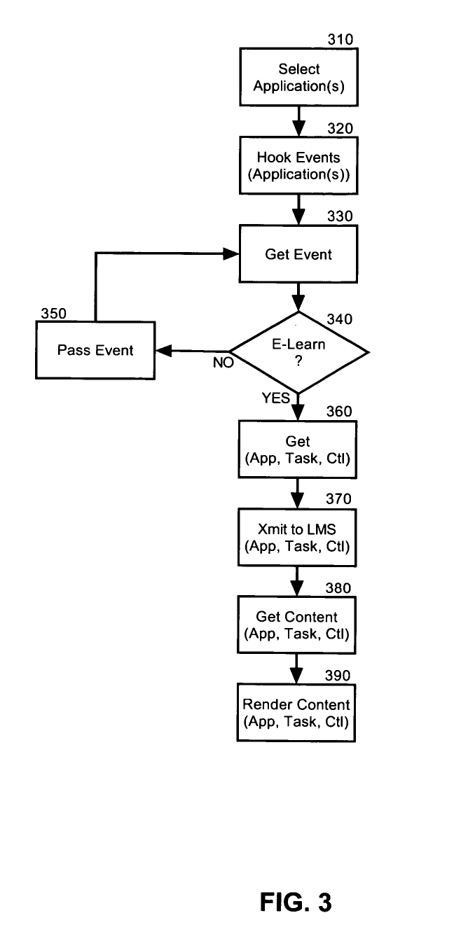

In yet further illustration, FIG. 3 is a flow chart illustrating a process for contextually invoking e-learning services for work-embedded e-learning. Beginning in block 310, one or more applications can be selected to be enabled for contextually invoking e-learning services for work-embedded e-learning. In block 320, an event hook can be established for each selected application separately from each selected application to trap a pre-configured event, such as a sequence of keystrokes. Subsequently, in block 330 events can be received through the established hook.

In decision block 340, if the trapped events do not correspond to the pre-configured event, in block 350 the trapped events can be passed to the default event handler. However, if in decision block 340 the trapped events do correspond to the pre-configured event, in block 360 the identity of the application, task and user interface control for the task can be retrieved. In this regard, the identity of the task can indicate an active task for the application and the identity of the user interface control can indicate a selected user interface control for the task. Notwithstanding, the user interface control need not be activated and, in one aspect of the invention, the user interface control need only have focus.

In block 370, the identity of the application, task and user interface control can be assembled into a search string and transmitted to a learning management system over a computer communications network. Subsequently, in block 380, e-learning content associated with the search string can be received from the learning management system and in block 390 the received e-learning content can be rendered in an e-learning view separate from the application. In consequence, on-demand, work-embedded learning can be provided without requiring modification to the underlying applications.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for on-demand work-embedded learning comprising:
trapping a pre-configured event for an application executing in a host computing platform in an event handler separate from the application;
identifying a context for the pre-configured event;
retrieving e-learning content corresponding to the identified context from a learning management system; and,
rendering the retrieved e-learning content in an e-learning content view which is separate from a view for the application in the host computing platform.

2. The method of claim 1, wherein trapping a pre-configured event for an application executing in a host computing platform in an event handler separate from the application, comprises trapping a pre-configured event generated by a sequence of keystrokes in the application.

3. The method of claim 1, wherein identifying a context for the pre-configured event, comprises identifying for the pre-configured event, an identity for each of an application, task within the application and associated user interface control for the application.

4. The method of claim 1, wherein retrieving e-learning content corresponding to the content from a learning management system, comprises:
generating a search string for the identified context;
transmitting the search string to a learning management system over a computer communications network; and,
receiving e-learning content corresponding to the search string from the learning management system.

5. The method of claim 3, wherein retrieving e-learning content corresponding to the content from a learning management system, comprises:
generating a search string for the identity of the application, task and user interface control;
transmitting the search string to a learning management system over a computer communications network; and,
receiving e-learning content corresponding to the search string from the learning management system.

6. A data processing system configured for on-demand work-embedded learning, the data processing system comprising:
a host computing platform communicatively coupled to a learning management system;
a plurality of applications executing in the host computing platform;
an e-learning view executing separately from the applications in the host computing platform; and,
e-learning invocation logic disposed in the host computing platform, the logic comprising program code enabled first to build a search string for a context responsive to detecting a pre-configured event originating from one of the applications, and second to provide e-learning content retrieved for the context from the learning management system to the e-learning content view.

7. The system of claim 6, wherein the e-learning view is a content browser configured to render markup language specified e-learning content.

8. The system of claim 6, wherein the context is an identity for each of an application, task within the application and associated user interface control for the application.

9. The system of claim 8, wherein the associated user interface control is a user interface control having focus during the pre-configured event.

10. A computer program product comprising a computer usable medium having computer usable program code for on-demand work-embedded learning, the computer program product including:
computer usable program code for trapping a pre-configured event in an application executing in a host computing platform in an event handler separate from the application;
computer usable program code for identifying a context for the pre-configured event;
computer usable program code for retrieving e-learning content corresponding to the identified context from a learning management system; and,
computer usable program code for rendering the retrieved e-learning content in an e-learning content view which is separate from a view for the application in the host computing platform.

11. The computer program product of claim 10, wherein the computer usable program code for trapping a pre-configured event in an application executing in a host computing platform in an event handler separate from the application, comprises computer usable program code for trapping a pre-configured event generated by a sequence of keystrokes in the application.

12. The computer program product of claim 10, wherein the computer usable program code for identifying a context for the pre-configured event, comprises computer usable program code for identifying for the pre-configured event, an identity for each of an application, task within the application and associated user interface control for the application.

13. The computer program product of claim 10, wherein the computer usable program code for retrieving e-learning content corresponding to the identified context from a learning management system, comprises:
computer usable program code for generating a search string for the identified context;
computer usable program code for transmitting the search string to a learning management system over a computer communications network; and,
computer usable program code for receiving e-learning content corresponding to the search string from the learning management system.

14. The computer program product of claim 12, wherein the computer usable program code for retrieving e-learning content corresponding to the identified context from a learning management system, comprises:
computer usable program code for generating a search string for the identity of the application, task and user interface control;
computer usable program code for transmitting the search string to a learning management system over a computer communications network; and,
computer usable program code for receiving e-learning content corresponding to the search string from the learning management system.
